(19) United States
(12) Patent Application Publication
(10) Pub. No.: US 2025/0284590 A1
(43) Pub. Date: Sep. 11, 2025

(54) SELF-HEALING AUTOMATIONS WITH SELF-SERVICE ARCHITECTURE

(71) Applicant: THE BANK OF NEW YORK MELLON, New York, NY (US)

(72) Inventors: Venkata R. SUDA, New York, NY (US); Anil Kiran VELLALA, New York, NY (US); William HOGAN, New York, NY (US)

(21) Appl. No.: 18/601,183

(22) Filed: Mar. 11, 2024

(51) Int. Cl. G06F 11/14; G06F 9/54

(52) U.S. Cl. CPC G06F 11/1402; G06F 9/542; G06F 11/07; G06F 11/0766; G06F 11/0769; G06F 11/2252

(57) ABSTRACT

The disclosure relates to systems and methods of self-healing automations. A system may access an indication of an occurrence of an event, an alert, or a situation detected at a channel in relation to a computer resource, wherein the event, the alert, or the situation indicates an alert state of the computer resource. The system may evaluate the event, the alert, or the situation against system may determine that one or more user-defined conditions for triggering the self-healing automation has been satisfied based on the evaluation. The system may identify a self-healing workflow based on the automation rule. The system may initiate the self-healing workflow to perform one or more remediation operations on the computer system.

### BACKGROUND

Computer systems may use complex technology stacks that include application services, databases, servers, network devices, and/or other computer resources. Along with this complexity is the possibility of multiple failure points in any one or more of these resources. Monitoring tools have therefore been developed to identify alert states, which may indicate an issue that requires mitigation to prevent degraded performance or failure of a computer resource. When issues are detected, responsible parties such as technology operations teams are notified a potential degradation or failure in the technology stack. Remediating these technology issues involves various technology support teams who own and manage the infrastructure components and services to remediate the issue. These systems can be slow to remediate issues and may result in an incorrect remediation. These and other issues may exist with remediating alert states in computer systems.

### SUMMARY

Various systems and methods may provide self-healing automation that automatically executes one or more automated workflows in response to automation rules that are triggered by a detected alert state. An alert state may be detected based on satisfaction of one or more conditions, which may be specified in an automation rule that triggers self-healing automation. A condition may include a requirement that an event, alert, and/or situation has been detected. The system may automatically evaluate incoming events, alerts, and/or situations against automation rules. The system may determine that an alert state exists based on the evaluation and trigger self-healing automation. The system may then identify a corresponding self-healing workflow, which is an automated workflow that includes computer operations for resolving alert states detected from events, alerts, and/or situations.

In some examples, the system may implement a self-service architecture to configure automation rules for self-healing automations. In these examples, responsible parties such as technology support teams may identify the conditions by which a self-healing automation is to be triggered and, in some implementations, specify one or more self-healing workflows that are to be initiated in response to an alert state. For example, the system may generate and provide an Intelligent Process Automation (IPA) portal that provides query (rule) building functionality. Responsible parties may use the IPA portal to build automation rules to onboard self-healing automations for computer resources for which they are responsible.

In particular, the IPA portal may provide a plurality of user-selectable options for configuring automation rules. The selectable options may include selectable conditions, selectable automation workflows that can be used as a self-healing workflow, user-input conditions, user-input automation workflows, and/or other components of an automation rule. As such, an automation rule may include user-defined conditions, user-defined self-healing workflows, and/or other user-selected options for generating automation rules.

In some examples, the selectable conditions may include predefined conditions that are already known by the system. In some examples, the selectable conditions may be provided by the user, which may then become predefined conditions for selection by the user and/or others. Likewise, the selectable self-healing workflows may include predefined automation workflows that are already known by the system. In these examples, because the self-healing workflows are already known and valid, testing these workflows may be unnecessary, improving the speed and flexibility in which these workflows can be deployed for various alert states. In some examples, the self-healing workflows may be provided by the user, which may then become predefined conditions for selection by the user and/or others.

In some implementations, the system may integrate self-healing automation across multiple channels of activity. Each channel may include an independently operating event management platform, distributed computing platforms, digital workflow platforms, customer inquiry and automation systems, and/or other platforms or services that may have alert states that can be self-healed based on the systems and methods disclosed herein. To facilitate multi-channel integration, the system may expose an automation Application Programming Interface (API) gateway that interfaces with a task automation platform. Each channel may use the automation API gateway for onboarding respective automation rules and make automation requests to trigger self-healing automations.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system for a self-service self-healing automation, according to an implementation.

FIG. 2 illustrates a schematic flow of an example of self-healing automation in the system of FIG. 1, according to an implementation.

FIG. 3 illustrates an example method of onboarding user-defined self-healing automation, according to an implementation.

FIG. 4 illustrates a schematic flow of an example of conducting self-healing automation, according to an implementation.

FIG. 5 illustrates a schematic flow diagram of an example multi-channel integration for self-healing automation, according to an implementation.

FIG. 6 illustrates a flow diagram of an example method of configuring self-healing automation through a portal interface, according to an implementation.

### DETAILED DESCRIPTION

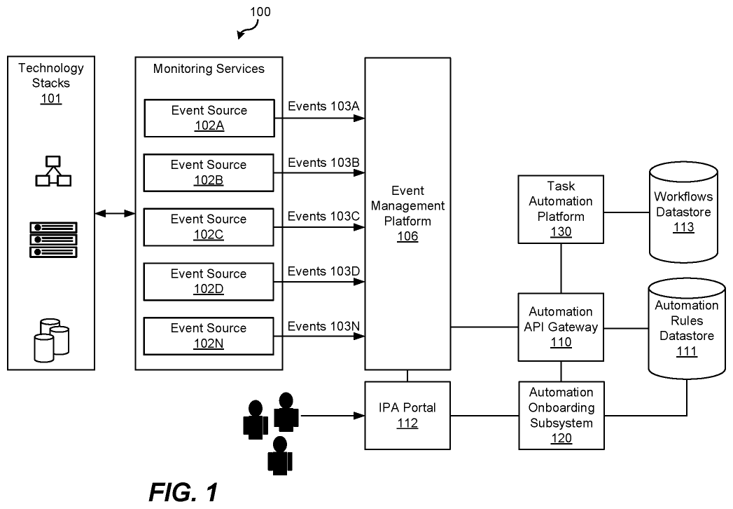

FIG. 1 illustrates an example of a system 100 for self-service self-healing automation, according to an implementation. Self-healing automation is the automatic execution of one or more computer operations in response to an alert state in an effort to eliminate, or mitigate against, the alert state. The operations may be organized into a self-healing workflow that may be used to automatically execute some or all of the operations (or portions thereof) serially or in parallel. An alert state is a potentially anomalous, otherwise non-normal or unexpected functioning of a computer resource that may require investigation, correction and/or mitigation. Examples of computer resources include, without limitation, an application service, a device, a network, or other computational asset.

Self-healing automation may be triggered by one or more user-defined conditions associated with a computer system. A user-defined condition may specify the occurrence of one or more events, one or more alerts, and/or one or more situations. An alert is a unique, non-redundant event. A situation is a cluster of alerts that may together indicate the existence of an alert state. The term self-service refers to users being able to configure conditions by which self-healing automation is to be triggered and, in some instances, one or more workflows or processes that should be automatically executed to address the alert state.

As shown in FIG. 1, the system 100 may include a technology stack 101 employed by the system 100, one or more event sources 102 (illustrated as event sources 102A-N), an event management platform 106, an Intelligent Process Automation (IPA) portal 112, an automation API gateway 110, an automation onboarding system 1220, a task automation platform 130, and/or other components. Each of the event management platform 106, IPA portal 112, and task automation platform 130 may be executed one or more computer systems. Each of these computer systems may include one or more processors programmed with the features described herein.

The technology stack 101 may include various computational resources used in a computer system. The computational resources may include, without limitation, application services, servers, datastores, networks, and/or other resources. Activity relating to computational resources may be passively or actively monitored by one or more event sources 102. An event source 102 is a source of an event that occurred at or associated with a monitored system in the technology stack 101. Examples of event sources include system monitoring and alerting platforms, log monitoring systems, network monitoring software, Application Programming Interfaces (APIs) that enable submission of events, manual entries from personnel, and/or other sources.

The event management platform 106 may access one or more of the events 103 from any one or more of the event sources 102. In some instances, the event management platform 106 may generate an alert based on the events 103. An alert is a unique (non-redundant) event 103 received by the event management platform 106. For example, the event management platform 106 may deduplicate two or more events 103 to generate a non-redundant alert based on the source, time, description, and/or other data of the two or more events. Deduplicated events are converted into alerts, which may encode the severity, source, and/or other details about the alert.

The event management platform 106 may cluster a plurality of alerts to generate a situation. The clustered alerts may together indicate an alert state that is to be corrected or otherwise mitigated. Clustering may be based on temporal proximity, topological proximity, content similarity, event correlations, and/or other techniques. Temporal proximity refers to alerts occurring within a threshold period of time with one another, indicating potential relatedness to the same alert state. Topological proximity refers to alerts from the same or interconnected components, potentially indicating a broader alert state across those components. Content similarity refers to similar descriptions, keywords, or error codes that may indicate a common root cause. Event correlations refers to identifying specific event sequences that collectively indicate an alert condition.

The automation API gateway 110 may provide an interface between the task automation platform 130 and other system components to onboard and execute self-healing automations. For example, the automation API gateway 110 may expose API actions (or calls) that enable clients of the automation API gateway 110 to onboard automation rules with the automation onboarding subsystem 120 and initiate self-healing workflows, which are stored in the workflows datastore 113, through the task automation platform 130.

The IPA portal 112 may provide one or more user interfaces for configuring automation rules, self-healing workflows, and/or other logic for facilitating self-healing automation. Through these and other specifications from users, the self-healing automation may be configured in a self-service manner. For example, the IPA portal 112 may generate and provide query (rule) building interfaces that include inputs for receiving conditions, self-healing workflows, and/or other data for generating an automation rule, which may be stored at the automation rules datastore 111.

The task automation platform 130 may be triggered to initiate self-healing workflows. In some examples, the task automation platform 130 may access a situation generated by the event management platform 106 and generate a situation ticket. A situation ticket is a trackable record that stores information about the situation to record the occurrence of the situation and any mitigative action taken and resolution. The situation ticket may be updated with progress, making the situation trackable.

The task automation platform 130 may map the situation with an appropriate self-healing workflow. For example, each type of situation may be mapped to an automation rule in the automation rules datastore 111. The automation rule may specify one or more self-healing workflows to be initiated to mitigate the situation. For example, each self-healing workflow may be assigned with a workflow identifier in the workflows datastore 113. The automation rules datastore 111 may store a mapping between a situation type and a workflow identifier. When an automation rule specifies that actions in a self-healing workflow should be triggered in response to a particular type of situation, then the mapping may be generated and stored in the automation rules datastore 111.

The task automation platform 130 may initiate execution of the self-healing workflows specified by the automation rule that is mapped to the situation. Initiating a self-healing workflow may include initiating execution of one or more self-healing processes that mitigate or otherwise address an alert state associated with a situation. Types of self-healing processes will vary depending on the particular configuration of the mitigative action to take in response to different alert states.

Non-limiting examples of self-healing processes in a self-healing workflow may include a process or device restart (such as when the alert state relates to a hung or non-executing service or device), disk space cleanup (such as when the alert state relates to running out of disk space), database diagnostic (such as when the alert state relates to database performance, security or data integrity), log file rotation (such as when the alert state relates to overly large log files), and/or other types of processes that can be executed to mitigate against alert states.

The task automation platform 130 may transmit notifications to one or more responsible parties that ultimately responsible for verifying that alert states are addressed, either by the self-healing systems described herein and/or via manual intervention by human users. An example of a responsible entity may include one or more service team members that are responsible for addressing alert states in their respective part of the technology stack 101 to which they are assigned. The notifications may include one or more status updates that include a progress of the initiated self-healing workflows. The notifications may be via electronic mail, Short Message Service), in-application messaging, and/or other types of notifications.

It should be noted that the functionality described with respect to the components of FIG. 1 may be shared across or otherwise conducted by different components. For example, some or all functionality of the event management platform 106 may be performed by the task automation platform 130 and vice versa.

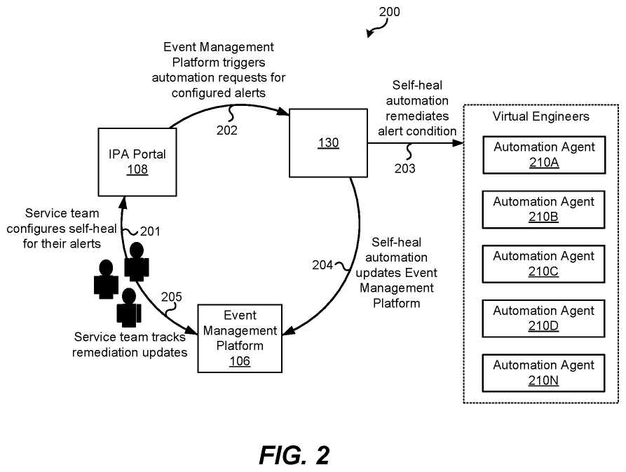

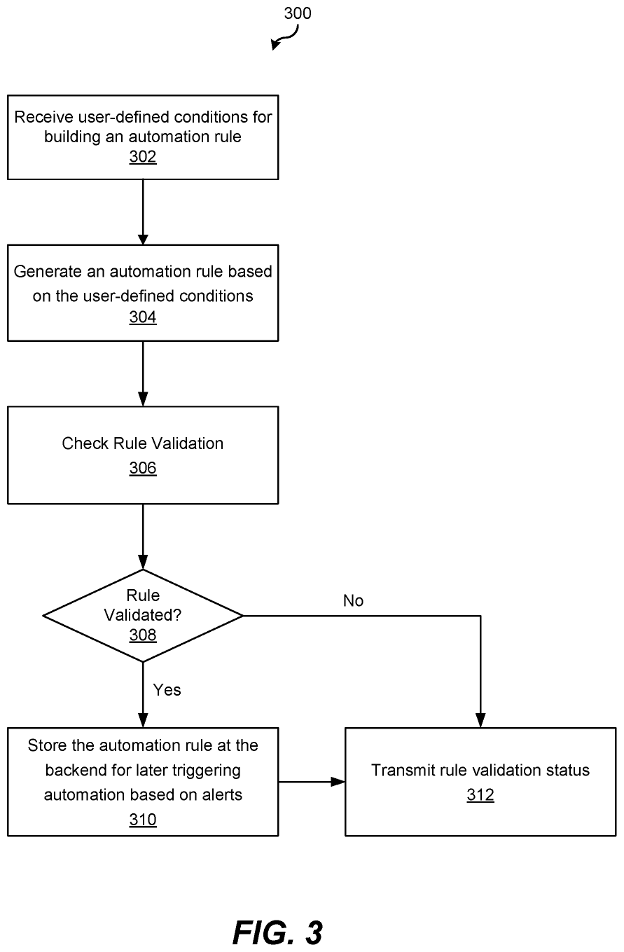

FIG. 2 illustrates a schematic flow 200 of an example of self-healing automation in the system of FIG. 1, according to an implementation. FIG. 2 will be described in the context of service team members configuring and monitoring execution of self-healing automation for their respective portion of a technology stack. At 201, a service team member may access the IPA portal 112 to configure self-healing automation for their alerts. A more detailed example of configuring self-healing automation is described with respect to FIG. 3. Once self-healing automation is configured, the event management platform 106 may monitor events, generate alerts and determine whether the alerts trigger a pre-configured self-healing automation.

At 202, the event management platform 106 may determine that an alert triggers a self-healing automation, and generates an automation request to execute a corresponding workflow. At

At 203, self-healing automation routines are executed in response to the automation request. For example, a self-healing workflow triggered by the alert may be associated with one or more virtual engineers that automatically execute to remediate the alert. A virtual engineer is computational logic that is programmed to execute one or more operations. For example, a virtual engineer may include one or more automation agents 210 (illustrated as automation agents 210A-N). Each automation agent 210 may include code that is executed to remedy the alert. An automation agent 210 may be programmed to perform a specific action in response to specific alerts. For example, an automation agent 210 may be programmed to cause a device to restart, a messaging channel to restart, an application service to restart, a storage backup system to restart, a disk to be cleaned up (excess data deleted), a database diagnostic to be executed, one or more log files to be rotated, and/or other functions that can be executed to resolve a corresponding and specific alert.

At 204, the self-healing automation may update the event management platform 106 with progress of the automatic self-healing process. These updates may be periodically made, including when the process is completed. At 205, the service member may track the updates via the event management platform 106 such as through the IPA portal 112.

FIG. 3 illustrates an example method 300 of onboarding user-defined self-healing automation, according to an implementation. At 302, the method 300 may include receiving user-defined conditions and self-healing actions for building an automation rule. A user-defined condition may specify how and when to identify and trigger alerts. For example, a user-defined condition may include one or more events, alerts, and/or situations (such as detection of a non-responsive device or service, a computational load exceeding a threshold value, a storage capacity exceeding a threshold disk space, a number of logon attempts exceeding a threshold attempts, and the like) that, if they are detected, trigger an alert. For example, a user may be presented with a user selectable set of conditions, which may be preconfigured in the event management platform 106. The user may select one or more of the conditions that should trigger self-healing automation. The output of the resulting automation rule may include the selected conditions in an interchange format, such as JavaScript Object Notation (JSON) or other exchangeable format. In some examples, at 302, the method 300 may further include receiving an identification of a service group that specifies responsible parties for the alert.

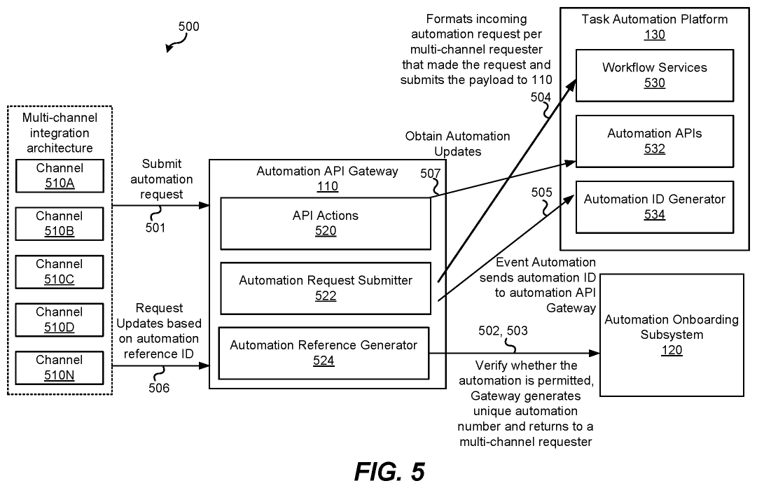

At 304, the method 300 may include generating an automation rule based on the user-defined conditions. The JSON or other formatted output may then be converted into a rule format that is readable by the event management platform 106. Thus, in some examples, as described further at FIG. 5, a multi-channel architecture in which different platforms configure automation rules can be facilitated.

At 306, the method 300 may include checking to determine whether the automation rule is valid. A validation result may include that the rule is valid, rejected, subject to further review, and/or other result. In some instances, an automation rule may not be valid due to security or other concerns. At 308, if the automation rule is valid, then at 310, the method 300 may include storing the automation rule and service group identity (if provided at 302) at the backend for self-healing automation based on alerts. For example, the automation rule may be mapped to one or more self-healing workflows for mitigating alert states associated with one or more alerts/situations. The method 300 may then proceed to 312, where the rule validation status (in this case, successfully stored) is transmitted. Returning to 308, if the rule is not valid, then the method 300 may proceed to 312 without storing the automation rule. Once the automation rule has been successfully onboarded and stored, the automation rule may be automatically matched against events, alerts, and/or situations to trigger self-healing automation described herein.

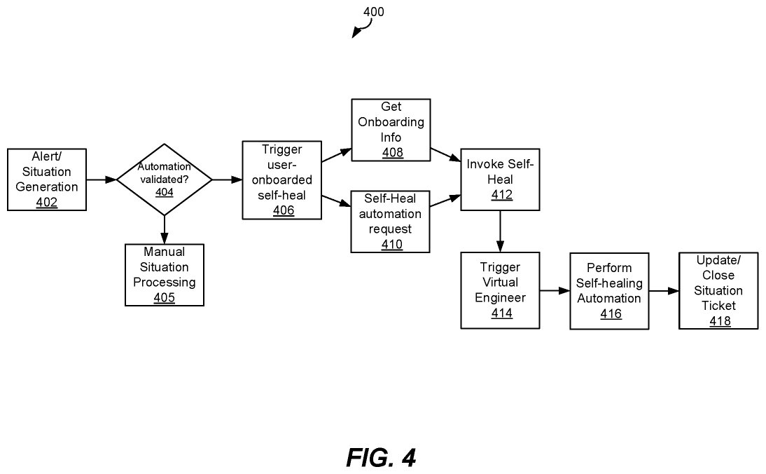

FIG. 4 illustrates a schematic flow 400 of an example of conducting self-healing automation, according to an implementation.

At 402, a situation is generated from one or more alerts. At 404, whether automation is validated for the situation is determined. If not, at 405, manual situation processing is to be performed and schematic flow 400 exits. Although not shown, an alert may be transmitted to responsible parties that manual situation processing is to be performed.

At 406, user-onboarded self-healing automation is triggered. For instance, the situation may have been onboarded via method 300 to trigger self-healing automation.

At 408, the onboarding information is obtained. At 410, a self-heal automation request is made, such as to the automation task automation platform 130.

At 412, self-healing is invoked at the automation task automation platform 130. At 414, one or more self-healing workflows may trigger execution of a virtual engineer, which includes one or more automation agents that execute self-healing operations such as those described at FIG. 2.

At 416, self-healing automation is performed, such as via execution of the one or more automation agents. At 418, the situation ticket is updated and/or closed depending on progress of the self-healing automation.

FIG. 5 illustrates a schematic flow diagram 500 of an example multi-channel integration for self-healing automation, according to an implementation. Multi-channel integration refers to an ability for different channels 502 (illustrated as channels 502A-N) to be onboarded to trigger self-healing automation for their respective of events, alerts, and situations. Each channel 510 may include an independently operating event management platform (such as event management platform 106), distributed computing platforms, digital workflow platforms, customer inquiry and automation systems, and/or other platforms or services that may have alert states that can be self-healed.

Each channel 510 may have events, alerts, situations, and/or their equivalents to these onboarded for automation rule generation, as described at FIG. 3. Once onboarded, each channel 510 may interface with the automation API gateway 110, which exposes API actions 520 for automation services. These API actions may include REST actions such as Representational State Transfer (RESTful) API calls. The automation API gateway 110 may include an automation reference generator 524 that obtains and returns unique automation reference numbers for automation requests, and an automation request submitter 522 that verifies and submits automation requests to backend automation systems, such as the automation task automation platform 130.

The automation task automation platform 130 may, in addition to or instead of features illustrated in FIG. 1, workflow services 530 that conducts and provides updates on self-healing workflows, automation APIs 532 that provides interfaces to the automation task automation platform 130, and an automation ID generator 534 that generates unique automation IDs.

In an example operation, at 501, a channel 510 may submit an automation request to the automation API gateway 110. The automation request may be a request to trigger a self-healing automation to mitigate an alert state at a monitored computer system.

At 502, the automation reference generator 524 may verify whether the automation is permitted. For example, automation may not be permitted when a rule associated with the alert state does not permit automation. For example, a given rule for an alert state may require manual or other type of intervention that is not an automated task.

At 503, the automation reference generator 524 may generate a unique automation reference ID and returns the automation reference ID back to the requesting channel 510. This automation reference ID may be used by the channel 510 to check for updates to the self-healing automation.

At 504, the automation request submitter 522 may format the automation request into a format accepted by the automation task automation platform 130.

At 505, the automation ID generator 534 generates an automation ID for the self-healing automation and returns the automation ID to back to the automation API gateway 110, which may store the automation ID and the automation reference ID in association with one another.

At 506, the requesting channel 510 may request and receive periodic updates regarding the progress of the automation request. For example, the requesting channel may transmit the automation reference ID to the automation API gateway 110, which may then lookup the corresponding automation ID. At 507, via API actions 520, the automation API gateway 110 may transmit the automation ID to the automation APIs 532 to obtain status updates.

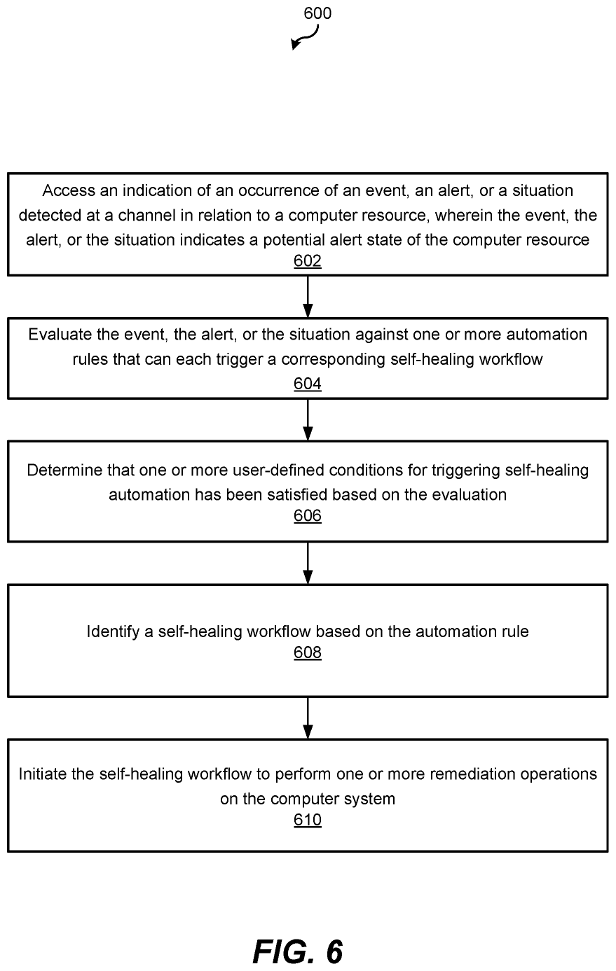

FIG. 6 illustrates a flow diagram of an example method 600 of self-healing automation, according to an implementation.

At 602, the method 600 may include accessing an indication of an occurrence of an event, an alert, or a situation detected at a channel in relation to a computer resource, wherein the event, the alert, or the situation indicates an alert state of the computer resource. At 604, the method 600 may include evaluating the event, the alert, or the situation against one or more automation rules that can each trigger a corresponding self-healing workflow. At 606, the method 600 may include determining that one or more user-defined conditions for triggering self-healing automation has been satisfied based on the evaluation. At 608, the method 600 may include identifying a self-healing workflow based on the automation rule. At 610, the method 600 may include initiating the self-healing workflow to perform one or more remediation operations on the computer system.

The datastores (such as 111 and 113) may be a database, which may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The datastores may include cloud-based storage solutions. The database may store a plurality of types of data and/or files and associated data or file descriptions, administrative information, or any other data. The various datastores may store predefined and/or customized data described herein.

Each of system components illustrated in the figures may include a processor programmed to execute or implement the functionality described herein by software; hardware; firmware; some combination of software, hardware, and/or firmware; and/or other mechanisms for configuring processing capabilities on processor. The processor may include one or more of a digital processor, an analog processor, a digital circuit designed to process information, an analog circuit designed to process information, a state machine, and/or other mechanisms for electronically processing information. In some embodiments, the processor may comprise a plurality of processing units. These processing units may be physically located within the same device, or the processor may represent processing functionality of a plurality of devices operating in coordination.

The description of the functionality provided by the different components is for illustrative purposes, and is not intended to be limiting, as any of the components or features may provide more or less functionality than is described, which is not to imply that other descriptions are limiting. For example, one or more of the components or features may be eliminated, and some or all of its functionality may be provided by others of the components or features, again which is not to imply that other descriptions are limiting. As another example, a given processor may include one or more additional components that may perform some or all of the functionality attributed below to one of the components or features.

Each of the system components illustrated in the figures may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

Each of the system components may be connected to one another via a communication network (not illustrated), such as the Internet or the Internet in combination with various other networks, like local area networks, cellular networks, or personal area networks, internal organizational networks, and/or other networks. It should be noted that the task automation platform 130 may transmit data, via the communication network, conveying the outcomes and situations to one or more client devices of responsible parties.

The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIG. 1.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access an indication of an occurrence of an event, an alert, or a situation detected at a channel in relation to a computer resource, wherein the event, the alert, or the situation indicates an alert state of the computer resource;
evaluate the event, the alert, or the situation against one or more automation rules that can each trigger a corresponding self-healing workflow;
determine that one or more user-defined conditions for triggering the self-healing automation has been satisfied based on the evaluation;
identify a self-healing workflow based on the automation rule; and
initiate the self-healing workflow to perform one or more remediation operations.

2. The system of claim 1, wherein the processor is further programmed to:
receive, from a responsible party associated with the alert state, the one or more user-defined conditions to onboard the self-healing automation;
generate the automation rule based on the one or more user-defined conditions and map the automation rule to the self-healing workflow; and
store the mapped automation rule and self-healing workflow for automated retrieval and matching.

3. The system of claim 2, wherein the processor is further programmed to:
before the self-healing workflow is associated with the alert state, transmit an indication of the alert state to the responsible party via an intelligent process automation portal, wherein the automation rule and corresponding self-healing workflow are configured based on input from the responsible party to set up automated self-healing for the alert state.

4. The system of claim 2, wherein the processor is further programmed to:
generate an output in an interchange format based on the one or more user-defined conditions; and
convert the output into a format that is compatible with the channel to support multi-channel integrations.

5. The system of claim 1, wherein the processor is further programmed to:
access an indication of an occurrence of a second event, a second alert, or a second situation detected at the channel in relation to the computer resource, wherein the second event, the second alert, or the second situation indicates a second alert state of the computer resource;
determine that the second alert state has not been onboarded for self-healing automation; and
transmit an indication for manual resolution by a second responsible party that is associated with the second alert state.

6. The system of claim 5, wherein the processor is further programmed to:
receive, from the second responsible party associated with the second alert state, a specification of a second automation rule and corresponding second self-healing workflow; and
store the second automation rule and corresponding second self-healing workflow in a self-healing datastore.

7. The system of claim 1, wherein the processor is further programmed to:
generate, responsive to the alert state, a tracking record;
determine one or more updates indicating a progress of the self-healing workflow; and
update the tracking record with the one or more updates.

8. The system of claim 1, wherein the channel comprises an event management platform, the system further comprising:
the event management platform, wherein the event management platform is programmed to:
receive one or more events associated with a technology stack,
generate an alert based on the one or more events,
cluster the alert with at least one other alert to generate a situation, and
generate an automation request to request the self-heal automation responsive to the situation.

9. The system of claim 8, further a comprising:
an automation computer system programmed to execute the self-healing workflow responsive to the automation request via a virtual engineer comprising one or more automation agents.

10. The system of claim 9, wherein the virtual engineer executes the one or more automation agents perform a computer process that addresses the alert state.

11. A method, comprising:
accessing, by a processor, an indication of an occurrence of an event, an alert, or a situation detected at a channel in relation to a computer resource, wherein the event, the alert, or the situation indicates an alert state of the computer resource;
evaluating, by the processor, the event, the alert, or the situation against one or more automation rules that can each trigger a corresponding self-healing workflow;
determining, by the processor, that one or more user-defined conditions for triggering the self-healing automation has been satisfied based on the evaluation;
identifying, by the processor, a self-healing workflow based on the automation rule; and
initiating, by the processor, the self-healing workflow to perform one or more remediation operations.

12. The method of claim 11, further comprising:
receiving, from a responsible party associated with the alert state, the one or more user-defined conditions to onboard the self-healing automation;
generating the automation rule based on the one or more user-defined conditions and map the automation rule to the self-healing workflow; and
storing the mapped automation rule and self-healing workflow for automated retrieval and matching.

13. The method of claim 12, further comprising:
before the self-healing workflow is associated with the alert state, transmitting an indication of the alert state to the responsible party via an intelligent process automation portal, wherein the automation rule and corresponding self-healing workflow are configured based on input from the responsible party to set up automated self-healing for the alert state.

14. The method of claim 12, further comprising:
generating an output in an interchange format based on the one or more user-defined conditions; and
converting the output into a format that is compatible with the channel to support multi-channel integrations.

15. The method of claim 11, further comprising:
accessing an indication of an occurrence of a second event, a second alert, or a second situation detected at the channel in relation to the computer resource, wherein the second event, the second alert, or the second situation indicates a second alert state of the computer resource;
determining that the second alert state has not been onboarded for self-healing automation; and
transmitting an indication for manual resolution by a second responsible party that is associated with the second alert state.

16. The method of claim 15, further comprising:
receiving, from the second responsible party associated with the second alert state, a specification of a second automation rule and corresponding second self-healing workflow; and
storing the second automation rule and corresponding second self-healing workflow in a self-healing datastore.

17. The method of claim 11, further comprising:
generating, responsive to the alert state, a tracking record;
determining one or more updates indicating a progress of the self-healing workflow; and
updating the tracking record with the one or more updates.

18. The method of claim 11, wherein the channel comprises an event management platform, the method further comprising:
receiving, by the event management platform, one or more events associated with a technology stack;
generating, by the event management platform, an alert based on the one or more events;
clustering, by the event management platform, the alert with at least one other alert to generate a situation; and
generating, by the event management platform, an automation request to request the self-heal automation responsive to the situation.

19. The method of claim 18, further a comprising:
executing, by an automation computer system, the self-healing workflow responsive to the automation request via a virtual engineer comprising one or more automation agents.

20. A non-transitory computer readable medium storing instructions that, when executed by a processor, programs the processor to:
access an indication of an occurrence of an event, an alert, or a situation detected at a channel in relation to a computer resource, wherein the event, the alert, or the situation indicates an alert state of the computer resource;
evaluate the event, the alert, or the situation against one or more automation rules that can each trigger a corresponding self-healing workflow;
determine that one or more user-defined conditions for triggering the self-healing automation has been satisfied based on the evaluation;
identify a self-healing workflow based on the automation rule; and
initiate the self-healing workflow to perform one or more remediation operations.
